(19) United States
(12) Patent Application Publication
(10) Pub. No.: US 2023/0220246 A1
(43) Pub. Date: Jul. 13, 2023

(54) USE OF HYDROTREATED SYNTHETIC FISCHER-TROPSCH-WAXES IN POLYOLEFIN-BASED HOT MELT ADHESIVES

(71) Applicant: SASOL SOUTH AFRICA LIMITED, Sandton (ZA)

(72) Inventors: Morris MOABELO, Germiston (ZA); Pieter VAN HELDEN, Vanderbijlpark (ZA)

(73) Assignee: SASOL SOUTH AFRICA LIMITED, Sandton (ZA)

(21) Appl. No.: 17/999,835

(22) PCT Filed: May 17, 2021
(86) PCT No.: PCT/IB2021/054201

§ 371 Date: Nov. 23, 2022

(30) Foreign Application Priority Data
May 28, 2020 (ZA) 2020/03162

(51) Int. Cl. C09J 7/35; C09J 123/00

(52) U.S. Cl. CPC C09J 7/35; C09J 123/00; C09J 2301/304; C09J 2301/312; C09J 2301/408

(57) ABSTRACT

The present invention is concerned with the use of hydrotreated synthetic Fischer-Tropsch waxes in polyolefin-based hot melt adhesive compositions, wherein the hydrotreated synthetic Fischer-Tropsch waxes modify the color degradation in the polyolefin-based hot melt adhesive compositions and are characterized by a polydispersity between 1.02 and 1.06.

### FIELD OF THE INVENTION

The present invention is concerned with the use of hydrotreated synthetic Fischer-Tropsch waxes in polyolefin-based hot melt adhesive compositions, wherein the hydrotreated synthetic Fischer-Tropsch waxes modify the color degradation in the polyolefin-based hot melt adhesive compositions and are characterized by a polydispersity between 1.02 and 1.06.

### DESCRIPTION OF THE PRIOR ART AND OBJECT OF THE INVENTION

Adhesives are, generally speaking, substances applied to one surface, or both surfaces, of two separate items (“adherends”) that bind them together and resist their separation by forming an adhesive bond between the items. Adjectives may be used in conjunction with the word “adhesive” to describe properties based on a particular adhesive's physical or chemical form, the type of materials joined, or conditions under which the adhesive is applied.

Hot melt adhesives (HMA) (“hot melts”) are one type of adhesives and are 100% non-volatile solid thermoplastics. During application a hot melt adhesive is applied to at least one of the substrates to be bonded at an elevated temperature in a molten state typically in the range of 65 to 180° C., brought into contact with the other substrate(s) and is then solidified upon cooling. Subsequently it forms a strong bond between these substrates. This almost instantaneous bonding makes hot melt adhesives excellent candidates for automated operations. Within these one of the most common application for hot melt adhesives includes binding of packaging materials. A typical hot melt adhesive is composed of base polymer(s), diluent wax(es) or oil(s), tackifier(s), stabilizers and optional filler(s).

The base polymer is the molecular backbone of the systems, and it is used to provide the inherent strength and chemical resistance as well as the application characteristics.

Oils and waxes are used to adjust viscosity and set times. Tackifiers are added to improve initial adhesion and to modify the base polymer.

Fillers are used to fine tune certain properties such as melt viscosity, thermal expansion coefficient, set time, etc.

Ethylene-vinyl acetate-polymer-based hot melts are particularly popular for crafts because of their ease of use and the wide range of common materials they can join.

Styrenic block copolymers are commonly employed in hot melt adhesives due to their dual characteristics, i.e. cohesion of the styrenic phase associated with the rubbery behavior of another phase.

Recently the use of metallocene-based and/or amorphous polyolefin hot melts has increased. They bond well to nonpolar substrates like polyethylene and polypropylene but are usually not recommended for polar surfaces. They also have good barrier properties, i.e. low moisture and water vapor permeability, and excellent chemical resistance against polar solvents and solutions including acids, bases, esters, and alcohols but only moderate heat resistance and poor chemical resistance against nonpolar solvents like alkanes, ethers, and oils. They can be formulated with a range of melt viscosities, hardness, softening points, surface tackiness, and open times. When compared with EVA and polyamide hot melt adhesives, polyolefins have extended open times for positioning of parts. They also have lower melt viscosity, and slower set times than comparable EVAs. They reduce gel and char formation, are odor free and colorless. Some polyolefins can be used without any additives, but often they are compounded with tackifiers, waxes, and plasticizers (mineral oil, poly-butene oil). They are compatible with many nonpolar solvents, and hot mold additives. Common polyolefins include amorphous (atactic) propylene (APP), amorphous propylene-ethylene (APE), amorphous propylene-butylene (APB), amorphous propylene-hexylene (APH), amorphous propylene-ethylene-butylene. These polyolefins have different hardness and softening points, which decrease in the following order: APP>APE>APB>APH, in accordance with decreasing crystallinity. All polyolefins have low energies of cohesion and low entanglement weights. The polymer chains are rather flexible which provides good interdiffusion and entanglement across the interface between the polyolefins and the low surface energy substrates. Under mechanical load, most of the strain is dissipated by deformation and disentanglement of the polymer chains. Cohesive failure with high peel energies is therefore the typical failure mode of polyolefins.

Polyolefin based hot melts are widely used in the packaging and non-wovens industry (feminine hygiene, diapers, etc.). They are suitable for adhering paper, (olefin) plastic films and metal foils to a variety of substrates.

Due to their ability to resist moisture and chemicals and to adhere to difficult-to-bond plastics like common polyolefin housings and parts, they also find many applications in the appliance, automotive, and product assembly industry. The most common polyolefin is polypropylene. It has a service temperature from −30° C. to 110° C.

Suitable commercial propylene polymers are available under a variety of trade designations including, e.g., the VISTAMAXX series of trade designations from ExxonMobil Chemical Company (Houston, Tex.) including VISTAMAXX 8880 propylene-ethylene copolymer. Suitable commercial ethylene alpha-olefin copolymers are also available under a variety of trade designations including, e.g., the KOATTRO series of trade designations from LyondellBasell including KOATTRO PB M 0600M polybutene-1-ethylene copolymer and the AFFINITY series of trade designations from The Dow Chemical Company including AFFINITY GA 1950 ethylene-octene copolymer.

Suitable classes of tackifying agents include, aromatic, aliphatic and cycloaliphatic hydrocarbon resins, mixed aromatic and aliphatic modified hydrocarbon resins, aromatic modified aliphatic hydrocarbon resins, and hydrogenated versions thereof; terpenes, modified terpenes and hydrogenated versions thereof; natural rosins, modified rosins, rosin esters, and hydrogenated versions thereof; low molecular weight polylactic acid; and combinations thereof.

Useful tackifying agents are commercially available under a variety of trade designations including, e.g., the ESCOREZ series of trade designations from ExxonMobil Chemical Company (Houston, Tex.) including, e.g. ESCOREZ 1310LC, ESCOREZ 5400, ESCOREZ 5637, ESCOREZ 5415; ESCOREZ 5600, ESCOREZ 5615. And ESCOREZ 5690, the EASTOTAC series of trade designations from Eastman Chemical Company (Kingsport, Tenn.) including, e.g., EASTOTAC H-100R, EASTOTAC H-100L, and EASTOTAC H130W, the WINGTACK series of trade designations from Cray Valley HSC (Exton, Pa.) including, e.g., WINGTACK 86, WINGTACK EXTRA, and WINGTACK 95, the PICCOTAC series of trade designations from Eastman Chemical Company (Kingsport, Tenn.) including, e.g., PICCOTAC 8095 and 1115, the ARKON series of trade designations from Arkawa Europe GmbH (Germany) including, e.g., ARKON P-125, the REGALITE and REGALREZ series of trade designations from Eastman Chemical Company including, e.g., REGALITE RI 125 and REGALREZ 1126, and the RESINALL series of trade designations from Resinall Corp (Severn, N.C.) including RESINALL R1030.

The hot melt adhesive can further contain plasticizers such as processing oils. Processing oils can include, for example, mineral oils, naphthenic oils, paraffinic oils, aromatic oils, castor oils, rape seed oil, triglyceride oils, or combinations thereof. As one skilled in the art would appreciate, processing oils may also include extender oils, which are commonly used in adhesives. The use of oils in the adhesives may be desirable if the adhesive is to be used as a pressure-sensitive adhesive to produce tapes or labels or as an adhesive to adhere nonwoven articles. In certain embodiments, the adhesive may not comprise any processing oils.

Further additives, such as antioxidants, stabilizers, plasticizers, adhesion promoters, ultraviolet light stabilizers, rheology modifiers, corrosion inhibitors, colorants (e.g. pigments and dyes), flame retardants, nucleating agents or filler such as carbon black, calcium carbonate, titanium oxide, zinc oxide, or combinations thereof may also be present.

Useful antioxidants include, e.g. pentaerythritol tetrakis [3, (3,5-di-tert-butyl-4-hydroxyphenyl)propionate], 2,2′-methylene bis(4-methyl-6-tert-butylphenol), phosphites including, e.g. tris-(p-nonylphenyl)-phosphite (TNPP) and bis(2,4-di-tert-butylphenyl)4,4′-diphenylene-diphosphonite, di-stearyl-3,3′-thiodipropionate (DST-DP), and combinations thereof. Useful antioxidants are commercially available under a variety of trade designations including, e.g., the IRGANOX series of trade designations including, e.g., IRGANOX 1010, IRGANOX 565, and IRGANOX 1076 hindered phenolic antioxidants, and IRGAFOS 168 phosphite antioxidant, all of which are available from BASF Corporation (Florham Park, N.J.), and ETHYL 702 4,4′-methylene bis(2,6-di-tert-butylphenol), which is available from Albemarle Corporation (Baton Rouge, La.).

Waxes can be used as nucleating agents, diluents or viscosity reducers in hot melt adhesives.

As nucleating agents, waxes improve the elongation at break of the polymer material in a HMA. As diluent waxes promote the wetting and reduce the (melt) viscosity of the adhesive formulation, which allows reduction of the cost and control of the speed of application of the adhesive. From the viewpoint of the improvement of the flexibility and also the improvement of the wettability due to a decrease in the viscosity, the content of the wax is decisive.

Waxes in general are mostly defined as chemical compositions, which have a drop melting point above 40° C., are polishable under slight pressure, are knead-able or hard to brittle and transparent to opaque at 20° C., melt above 40° C. without decomposition, and typically melt between 50 and 90° C. with exceptional cases up to 200° C., form pastes or gels and are poor conductors of heat and electricity.

Waxes can be classified according to various criteria such as e.g. their origin. Here, waxes can be divided into two main groups: natural and synthetic waxes. Natural waxes can further be divided into fossil waxes (e.g. petroleum waxes) and nonfossil waxes (e.g. animal and vegetable waxes). Petroleum waxes are divided into macrocrystalline waxes (paraffin waxes) and microcrystalline waxes (microwaxes). Synthetic waxes can be divided into partially synthetic waxes (e.g. amide waxes) and fully synthetic waxes (e.g. polyolefin- and Fischer-Tropsch waxes).

Paraffin waxes originate from petroleum sources. They are clear, odor free and can be refined for food contact. They contain a range of (primarily) n-alkanes and iso-alkanes as well as some cyclo-alkanes. Raw or crude paraffin waxes (slack waxes) have a great number of short-chained alkanes (“oils”), which are removed when further refined. Different distributions and qualities of paraffin waxes can be obtained. Refining may include deoiling, distillation and hydrotreating.

Synthetic Fischer-Tropsch waxes or hydrocarbons originating from the catalyzed Fischer-Tropsch synthesis of syngas (CO and H₂) to alkanes contain predominantly n-alkanes, a low number of branched alkanes and basically no cyclo-alkanes or impurities like e.g. sulfur or nitrogen. In return, the number of olefins and oxygenates (i.e. oxidized hydrocarbons such as alcohols, esters, ketones and/or aldehydes) may be higher and different to petroleum-based waxes. Fischer-Tropsch waxes can also be further refined, e.g. to remove the amount of oxygenates. This may include deoiling, distillation and hydrotreating as well.

Hydrotreating Fischer-Tropsch waxes may be conducted catalytically using any suitable technique known to persons skilled in the art of wax hydrotreating. Typically, the FT-wax is hydrotreated using hydrogen at an absolute pressure between about 30 and about 70 bar, e.g. about 50 bar and an elevated temperature between about 150 and about 250° C., e.g. about 220° C. in the presence of a Nickel-catalyst, such as NiSat 310 available from Sued-Chemie SA (Pty) Ltd of 1 Horn Street, Chloorkop, 1624, South Africa.

Hydrotreating of FT-waxes is to be understood as a process in which impurities such as alcohols or other compounds containing oxygen and unsaturated hydrocarbons such as olefins are converted to alkanes by a catalytic reaction with hydrogen. It does not include cracking reactions such as hydroisomerization or hydrocracking and therefore does not change the chain length distribution and ratio of branched to linear molecules.

Fischer-Tropsch waxes can generally be classified in low melting (congealing point of 20 to 45° C.), medium melting (congealing point of 45° C. to 75° C.) and high-melting (congealing point of 75 to 110° C.).

Another source for synthetic waxes is products obtained from the oligomerization/polymerization of olefinic monomers, possibly followed by hydrogenation.

Fischer-Tropsch waxes are waxes according to the above definition comprising predominantly hydrocarbons. Hydrocarbons are molecules that exclusively consist of carbon and hydrogen atoms. If not otherwise mentioned n- or linear refers to a linear and aliphatic and i-, iso- or branched stands for branched and aliphatic.

The carbon chain length distribution and ratio of branched to linear alkanes in Fischer-Tropsch waxes can be determined by high temperature gas chromatography according to the Standard Test Method for Analysis of Hydrocarbon Waxes by Gas Chromatography (EWF Method 001/03) of the European Wax Federation (EWF). The GC-data can also be used to determine the polydispersity (ÐM=Mw/Mn) of the wax, which is calculated from the ratio of the weight average to the number average of wax alkanes and reflects the width of molecular weight distribution. The smaller this number is the narrow the molecular weight distribution. A completely homogeneous (wax) polymer theoretically has a polydispersity of 1.

Generally, waxes are included at levels of 20-30% in hot melt adhesive formulations, properties affected by the wax content are blocking characteristics, softening point, and open time. The high melting microcrystalline waxes (m.p. 90° C.) and synthetic waxes (m.p. 75-110° C.) are used because they contribute to high temperature properties and greater cohesive strength. The high melting paraffin waxes (m.p. 65-70° C.) are used extensively in hot melt coatings for their barrier, anti-blocking and heat seal properties, as well as their lower cost.

When used in polyolefin-based HMAs Fischer-Tropsch waxes such as SASOLWAX H1, SASOLWAX C105/H105 and/or SASOLWAX C80/C80M (whereas C80M is a unhydrotreated version of C80) obtainable from Sasol Wax GmbH, Hamburg, Germany or Sasol South Africa Limited, Sasolburg, South Africa provide short set times, a high cleavage temperature and great SAFT- and PAFT-values. SARAWAX SX105 is a Fischer-Tropsch wax from Shell.

The set time is the time it takes to form an acceptable bond when two or more substrates are combined with an adhesive. It can be determined on an ITW Dynatec glue testing unit at 170° C. The set time is determined by varying the pressing time when applying a certain force at an open time of 0.1 seconds and a pump speed of 25 rpm. To compensate for paper variance and environmental conditions, this force is determined daily by benchmarking against a standard. The set time is equal to the pressing time that gives 50% fibre tear when using single fluted corrugated board.

The cleavage temperature can be determined based on the method described in US20090203847 with an initial temperature at 40° C. (kept constant for 20 minutes) and increase in temperature of 12° C./hour and a weight of 100 g attached to the test piece in an oven. The cleavage temperature is the oven temperature noted when the sample bonding fails and represents the heat resistance of the sample. The test pieces are prepared by applying an adhesive bead at 170° C. on a single fluted corrugated board. After adhesive application another corrugated piece is placed immediately on the adhesive bead with a weight of 100 g on top of this. The bond is left at least 24 hours before testing.

The SAFT (Shear adhesion fail temperature) is determined based on ASTM D 4498 with initial temperature at 40° C. (kept constant for 25 minutes), increase in temperature of 30° C./hour and a weight of 500 g attached to the test piece. Kraft paper test pieces are prepared by the ITW Dynatec glue testing unit with compression force of 200 N, open time of 0.1 second, pressing time equal to set time plus 1 second and a pump speed of 15 rpm.

The PAFT (Peel adhesion fail temperature) is determined based on a modification of ASTM D4498 with initial temperature at 50° C. (kept constant for 15 minutes), increase in temperature of 30° C./hour and a weight of 100 g attached to the test piece. Kraft paper test pieces are prepared by the ITW Dynatec glue testing unit with compression force of 200 N, open time of 0.1 second, pressing time equal to set time plus 1 second and a pump speed of 15 rpm.

But as with other organic materials, waxes are susceptible to autoxidation and will lose their original properties over time. This may result in color degradation of the wax alone or together with the polymer. Usually these effects are checked by thermal ageing at higher temperatures, e.g. at 170° C. for 4 days.

Typical chemical processes happening in hydrocarbon waxes during thermal decomposition at high temperatures are based on radical chain mechanisms, i.e. the free radicals are reacting with the hydrocarbon chain, break it and form shorter chains and/or unsaturated chains, which can again react with oxygen and form oxygenates, which are mostly responsible for color degradation and/or odor.

The color of petroleum-based products including waxes is often determined according to the Saybolt color scale, which is defined in the standard ASTM D 156. The scale ranges from +30 (lightest grade) until −16 (darkest grade). Fischer-Tropsch waxes usually have a Saybolt color of between 0 to +30, whereas hydrogenation increases this number, typically to +26 to +30.

In hot melt adhesives the color is often rated according to the one-dimensional Gardner scale, which measures the shade of the color yellow (ASTM D 1544), but this can only be used for transparent liquids, that means the adhesive needs to be in its molten form, and is not very accurate.

Other ways of determining the color, especially if it comes to color degradation of hot melt adhesive compositions, are known from the polymer industry such as the measurement of the CIELab values (ASTM D 2244). It is also better related to the subjective color and lightness perception of the human vision. For this method a picture of the relevant specimens is made with a digital camera and the sRGB colors of the digital image can be converted into CIELab values by a suitable software, such as ImageJ or Adobe Photoshop. This gives the following values: L for lightness if the specimen, a for green and magenta and b for yellow and blue, whereas L is equal to 0 for the darkest black and equal to 100 for the brightest white. These values can be used to plot the color degradation of a hot melt adhesive sample over time at a specific temperature, for example at 170° C. in an oven. For that the relative color perception change of a specimen is calculated based on the formula 1 below at distinct time spots and plotted over time. The gradient of the linear fit of this plotted data resulted in the average linear color degradation rate of the according specimen.

$$Δ {E}_{00}^{⋆} = \sqrt{{( \frac{Δ {L}^{′}}{{k}_{L} {S}_{L}} )}^{2} + {( \frac{Δ {C}^{′}}{{k}_{C} {S}_{C}} )}^{2} + {( \frac{Δ {H}^{′}}{{k}_{H} {S}_{H}} )}^{2} + {R}_{T} \frac{Δ {C}^{′}}{{k}_{C} {S}_{C}} \frac{Δ {H}^{′}}{{k}_{H} {S}_{H}}} \qquad Formula 1$$

As the relative color change is also strongly dependent on the mixing conditions of the hot melt adhesive compositions and for example the heat- and ageing history of respective sample, the absolute data of different color degradation runs cannot be directly compared with each other, but only data for samples used within the same run are comparable.

Usually various antioxidants and/or stabilizers can be used to improve the thermal stability of hot melt adhesives and/or waxes. However, the use of a high molecular weight, less volatile antioxidant such as Irganox 1010 significantly outperforms the more volatile antioxidants during high temperature processing.

There have been approaches in the prior art to modify the polymer itself or use complex stabilizer systems to improve the color stability in general and specifically in hot melt adhesives.

For example US20130253105A1 discloses polymer compositions comprising polyolefin homo- and copolymers and poly(phenylene ether), which are substantially stainless reflected by a CIELab color shift (QE) of 3 or less after 158 hours of heat exposure at 75° C.

U.S. Pat. No. 4,835,200 discloses color stable hot melt adhesives containing a block copolymer, which was prepared using a bromide-based coupling agent, a tackifying resin and an effective amount of stabilizer composition. Optionally, the adhesive composition may also contain a petroleum derived wax. The color stability is determined by comparing the increase of the Gardner color after ageing the composition at 177° C. for a certain time (24 and 48 hours).

U.S. Pat. No. 5,266,649 discloses color stable diene polymers and hot melt adhesives containing them, whereas the color stability originates from a specific silane-based coupling agent used to polymerize the dienes as well as antioxidants and the color stability is reflected by slower increase of the Gardner color over time, while heating the polymer to 177° C. Waxes are not used herein.

EP2723825B1 discloses hot melt adhesive compositions including functionalized polyethylene and propylene-alpha-olefin polymers, which are modified with a free radical initiator. The adhesive may further comprise at least one Fischer-Tropsch wax, polyethylene wax, polypropylene wax and maleated polypropylene wax. The increase of the Gardner color of the according adhesive compositions was determined after ageing at 177° C. for 48 and 96 hours.

EP2292712A1 discloses the use of carbodiimides next to other antioxidants as color stabilizer in hot melts. The color change after thermal ageing of the hot melt at 130° C. was measured using the CIELab-color scheme and comparing the L, a, and b-values before and after ageing directly.

Nevertheless, there still exists the need to provide waxes, which decrease the color degradation of hot melt adhesives comprising them.

### SUMMARY OF THE INVENTION

It was surprisingly found that according to one, broad, aspect of the invention, the color degradation of polyolefin-based hot melt adhesives can be modified by the use of a hydrotreated synthetic Fischer-Tropsch wax in producing hot melt adhesive compositions, wherein the hydrotreated synthetic Fischer-Tropsch wax is characterized by
a congealing point in a range of 75 to 110° C.;
a Saybolt-color according to ASTM D 156 below or equal to 29; and
a polydispersity ÐM=Mw/Mn of between 1.02 and 1.06.

Thus, in accordance with a broad aspect of the invention is provided use of a hydrotreated synthetic Fischer-Tropsch wax of the type described in modifying the color degradation of polyolefin-based hot melt adhesives.

Therefore, what is also provided is a process of modifying the color degradation of polyolefin-based hot melt adhesives using a hydrotreated synthetic Fischer-Tropsch wax of the type described.

Such use and process may include blending a hydrotreated synthetic Fischer-Tropsch wax of the type described with a composition for producing a polyolefin-based hot melt adhesive, the composition comprising at least one polyolefin polymer.

By “modified” in the sense of modifying the color degradation of polyolefin-based hot melt adhesives is meant that the synthetic Fischer-Tropsch wax improves the color degradation characteristics of polyolefin-based hot melt adhesives, in the context of color degradation being an undesired characteristic. Thus, an improvement thereof would include a decrease (reduction) in color degradation of polyolefin-based hot melt adhesives over time.

According to another, more specific, aspect of the invention, is provided a polyolefin-based hot melt adhesive composition comprising at least one polyolefin polymer and a hydrotreated synthetic Fischer-Tropsch wax characterized by
a congealing point in a range of 75 to 110° C.;
a Saybolt-color according to ASTM D 156 below or equal to 29; an
a polydispersity ÐM=Mw/Mn of between 1.02 and 1.06.

According to a further, more specific, aspect of the invention is provided a method of modifying the color degradation of polyolefin-based hot melt adhesives, the method including blending a hydrotreated synthetic Fischer-Tropsch wax with a composition for producing a polyolefin-based hot melt adhesive, the composition comprising at least one polyolefin polymer, wherein the hydrotreated synthetic Fischer-Tropsch wax is characterized by
a congealing point in a range of 75 to 110° C.;
a Saybolt-color according to ASTM D 156 below or equal to 29; and
a polydispersity ÐM=Mw/Mn of between 1.02 and 1.06.

Thus, the method includes producing a composition comprising at least one polyolefin polymer and a hydrotreated synthetic Fischer-Tropsch wax of the type described.

According to yet a further, more specific, aspect of the invention is provided a method of producing polyolefin-based hot melt adhesives, the method including blending a hydrotreated synthetic Fischer-Tropsch wax with a composition for producing a polyolefin-based hot melt adhesive, the composition comprising at least one polyolefin polymer, wherein the hydrotreated synthetic Fischer-Tropsch wax is characterized by
a congealing point in a range of 75 to 110° C.;
a Saybolt-color according to ASTM D 156 below or equal to 29; and
a polydispersity ÐM=Mw/Mn of between 1.02 and 1.06.

Thus, the method includes producing a composition comprising at least one polyolefin polymer and a hydrotreated synthetic Fischer-Tropsch wax of the type described.

The inventive selection of the hydrotreated synthetic Fischer-Tropsch wax (hereinafter referred to as Fischer-Tropsch wax) provides a superior hot melt adhesive with a reduced color degradation over time, especially at high temperatures.

It is not required to use specific polymers and/or stabilizer system to improve the color stability. The inventive use of the Fischer-Tropsch waxes allows the reduction of the color degradation of the hot melt adhesive composition without amending the formulation itself. This is a cheap and effective method.

The color degradation is preferably determined by the change of the CIELab values of the hot melt adhesive composition over time at a specific temperature, for example at 170° C. in an oven. For that the relative color perception change of the hot melt adhesive composition is calculated based on the formula 1 above at distinct time spots and plotted over time. The gradient of the linear fit of this plotted data resulted in the average linear color degradation rate of the according hot melt adhesive composition.

Fischer-Tropsch waxes are obtained by the Fischer-Tropsch synthesis and are according to the invention preferably defined as hydrocarbons originating from the Cobalt- or Iron-catalyzed Fischer-Tropsch synthesis of syngas (CO and H₂) to alkanes. The crude product of this synthesis is separated into liquid and different solid fractions by distillation, which can be hydrotreated afterwards. The hydrocarbons contain predominantly n-alkanes, a low number of branched alkanes and basically no cyclo-alkanes or impurities like e.g. sulfur or nitrogen.

Fischer-Tropsch waxes consist of methylene units and their carbon chain length distribution is according to one embodiment characterized by an evenly increasing and decreasing number of molecules for the particular carbon atom chain lengths involved. This can be seen in gas chromatography-analyses of the wax.

Fischer-Tropsch waxes preferably have a content of branched hydrocarbons between 10 and 25 wt.-%. The branched molecules of the Fischer-Tropsch wax more preferably contain more than 10 wt.-%, most preferably more than 25 wt.-% molecules with methyl branches. Furthermore, the branched molecules of the Fischer-Tropsch wax preferably contain no quaternary carbon atoms. This can be seen in NMR-measurements of the wax.

The congealing point of the Fischer-Tropsch wax preferably is in the range of 90 to 105° C.

The Saybolt-color of the Fischer-Tropsch wax according to ASTM D 156 preferably is below or equal to 10.

The polydispersity ÐM=Mw/Mn of the Fischer-Tropsch wax preferably is between 1.03 and 1.05.

In preferred embodiments of the invention the Fischer-Tropsch wax has a molecular mass (number average) between 500 and 1200 g·mol⁻¹, more preferred between 600 and 1000 g·mol⁻¹ and most preferred between 880 and 920 g·mol⁻¹.

In preferred embodiments the Fischer-Tropsch wax additionally has independent of each other one or more of the following properties:
a heat of fusion determined with differential scanning calorimetry of 200 to 250 J/g, more preferably of 207 to 245 J/g, even more preferably of 210 to 240 J/g and most preferably of 220 to 235 J/g;
a penetration at 25° C. of below or equal to 5 1/10 mm, more preferably below or equal to 1 1/10 mm;
a penetration at 40° C. of below or equal to 10 1/10 mm; and
a Brookfield viscosity at 135° C. of above or equal to 10 mPa·s, more preferably above or equal to 12 mPa·s.

In a further preferred embodiment the Fischer-Tropsch wax is used in an amount of 2 to 40 wt.-%, preferably 5 to 30 wt.-% in the polyolefin-based hot melt adhesive composition.

At least one polyolefin polymer is present in the hot melt adhesive composition.

Preferably, the hot melt adhesive composition includes at least one polyolefin polymer in the range of 20 to 80 wt.-%, more preferably in the range of 40 to 50 wt.-%.

Optionally an antioxidant is comprised in the hot melt adhesive composition, preferably in the range of 0.1 to 2 wt.-%.

Furthermore, the composition may comprise a tackifier, preferably in an amount of 10 to 50 wt.-%, more preferably 20 to 40 wt.-% and/or a processing oil, preferably in an amount of 5 to 15 wt.-%.

The tackifying agent (“tackifier”) may be selected from aromatic, aliphatic and cycloaliphatic hydrocarbon resins, mixed aromatic and aliphatic modified hydrocarbon resins, aromatic modified aliphatic hydrocarbon resins, and hydrogenated versions thereof; terpenes, modified terpenes and hydrogenated versions thereof; natural rosins, modified rosins, rosin esters, and hydrogenated versions thereof; low molecular weight polylactic acid; and combinations thereof.

The processing oil may be selected, for example, from mineral oils, naphthenic oils, paraffinic oils, aromatic oils, castor oils, rape seed oil, triglyceride oils, or combinations thereof. As one skilled in the art would appreciate, processing oils may also include extender oils, which are commonly used in adhesives.

The polyolefin polymer in the adhesive composition may be selected from amorphous poly-alpha-olefin copolymers (APAO), polypropylene homopolymers or polybutene homopolymers, preferably from the group of ethylene-propylene copolymers, ethylene-butene copolymers or ethylene-octene copolymers, more preferably with an ethylene- or propylene content of more than or equal to 50 wt.-%.

All congealing points mentioned herein have been measured according to ASTM D 938 and all ring and ball softening points for the polymers according to ASTM E 28.

The Brookfield viscosity of the polymers at 190° C. and for the Fischer-Tropsch waxes at 135° C. has been measured according to ASTM D 3236 with spindle 27. The viscosity for the Fischer-Tropsch waxes has been measured according to ASTM D 445.

The needle penetration at 25° C. has been measured according to ASTM D 1321 and the glass transition point (Tg) of the polymers according to ASTM D 3418.

The molar mass (number average) and the iso-alkane content of the Fischer-Tropsch waxes was determined by gas chromatography according to EWF Method 001/03 of the European Wax Federation. The polydispersity ÐM=Mw/Mn of the Fischer-Tropsch waxes was calculated based on this data.

The heat of fusion determined with differential scanning calorimetry was measured according to ASTM E 793.

### EXAMPLES

Different polymers (see table 1) and Fischer-Tropsch waxes (see table 2) have been used to prepare a variety of hot melt adhesive compositions (hereinafter from time to time referred to as “formulations”) (see tables 3 to 5) by melt blending.

The melt blending was conducted in a mixing vessel at 150° C. In the first step the antioxidant and half the amount of polymer, as well as half the amount of wax were mixed for 10 minutes at 60 rpm until the polymer was completely molten. In a second step half the amount of resin was added and mixed for 15 minutes at 60 rpm. In a third step the rest of the polymer and wax were added and mixed for 10 minutes at 60 rpm until completely molten. In a last step the mixture was transferred into a release coated container, cooled down and solidified.

TABLE 1
Data of used polymers

| | Affinity | Koattro | Vistamaxx |
|---|---|---|---|
| | GA 1950 | PB M 600M | 8880 |
| Brookfield | 17000 | 13500 | 1200 |
| viscosity @190° C. | @177° C. | | |
| [mPa · s] | | | |
| ASTM D 3236 | | | |
| R&B softening | 70 | n.d. | 97 |
| point [° C.] | | | |
| ASTM E 28 | | | |
| Density [g · cm⁻³] | 0.874 | 0.89 | 0.879 |
| Tg [° C.] | −56.1 | n.d. | −22 |
| ASTM D 3418 | | | |

TABLE 2
Data of used Fischer-Tropsch waxes

| | SX 105-1 | C105-1 | C105-2 | C105-3 | C105-4 | C80 | C80M |
|---|---|---|---|---|---|---|---|
| Congealing point [° C.] | 101 | 102 | 102 | 102 | 102 | 83 | 78 |
| ASTM D 938 | | | | | | | |
| Saybolt color ASTM D 156 | 30 | 3 | 21 | 23 | 26 | 28 | 16 |
| Brookfield viscosity | 10.9 | 13.0 | 13.0 | 13.0 | 13.0 | 4.0 | 3.7 |
| @135° C. [mPa · s] | | | | | | | |
| Penetration @25° C. | 1 | 1 | 1 | 1 | 1 | 7 | 7 |
| [1/10 mm] ASTM D 1321 | | | | | | | |
| Penetration @65° C. | 9 | 9 | 9 | 9 | 9 | 66 | 51 |
| [1/10 mm] ASTM D 1321 | | | | | | | |
| Molar mass (number | 920 | 900 | 900 | 900 | 900 | 600 | 600 |
| average) [g · mol⁻¹] | | | | | | | |
| Iso-alkanes [wt.-%] | 10 | 10 | 10 | 10 | 10 | 12.4 | 12.4 |
| Polydispersity | 1.069 | 1.038 | 1.038 | 1.038 | 1.038 | 1.023 | 1.023 |

TABLE 3
Composition of hot melt adhesives with Affinity GA 150

| | 1 | 2 | 3 | | | | |
|---|---|---|---|---|---|---|---|
| Formulation | comp. | comp. | comp. | 4 | 5 | 6 | 7 |
| Polymer | 45.5 | 45.5 | 45.5 | 45.5 | 45.5 | 45.5 | 45.5 |
| (Affinity | | | | | | | |
| GA 1950) | | | | | | | |
| Tackifier | 34 | 34 | 34 | 34 | 34 | 34 | 34 |
| (Eastotac | | | | | | | |
| H130W) | | | | | | | |
| Antioxidant | 0.5 | 0.5 | 0.5 | 0.5 | 0.5 | 0.5 | 0.5 |
| (Irganox 1010) | | | | | | | |
| C80M | 20 | | | | | | |
| C80 | | 20 | | | | | |
| SX105 | | | 20 | | | | |
| C105-1 | | | | 20 | | | |
| C105-2 | | | | | 20 | | |
| C105-3 | | | | | | 20 | |
| C105-4 | | | | | | | 20 |

TABLE 4
Composition of hot melt adhesives with Koattro PB M 600M

| | 8 | 9 | 10 | | | |
|---|---|---|---|---|---|---|
| Formulation | comp. | comp. | comp. | 11 | 12 | 13 |
| Polymer | 45.5 | 45.5 | 45.5 | 45.5 | 45.5 | 45.5 |
| (Koattro PB M 600M) | | | | | | |
| Tackifier | 34 | 34 | 34 | 34 | 34 | 34 |
| (Eastotac H130W) | | | | | | |
| Antioxidant | 0.5 | 0.5 | 0.5 | 0.5 | 0.5 | 0.5 |
| (Irganox 1010) | | | | | | |
| C80M | 20 | | | | | |
| C80 | | 20 | | | | |
| SX105 | | | 20 | | | |
| C105-1 | | | | 20 | | |
| C105-3 | | | | | 20 | |
| C105-4 | | | | | | 20 |

TABLE 5
Composition of hot melt adhesives with Vistamaxx 8880

| Formulation | 14 comp. | 15 comp. | 16 comp. | 17 | 18 |
|---|---|---|---|---|---|
| Polymer (Vistamaxx 8880) | 45.5 | 45.5 | 45.5 | 45.5 | 45.5 |
| Tackifier (Eastotac H130W) | 34 | 34 | 34 | 34 | 34 |
| Antioxidant (Irganox 1010) | 0.5 | 0.5 | 0.5 | 0.5 | 0.5 |
| C80M | 20 | | | | |
| C80 | | 20 | | | |
| SX105 | | | 20 | | |
| C105-3 | | | | 20 | |
| C105-4 | | | | | 20 |

All formulations have been thermally aged for 96 hours in an oven at 170° C. At certain time intervals HMA buttons were cast in a silicone mould to produce test samples for colour stability analyses. The test samples, in a specific set, were then compared against the zero aged sample to produce comparative results. For that the CIElab-color values of the test samples were determined by taking a picture of the according sample with a digital camera and converting the RGB colors thereof in CIELab values with the ImageJ-software. The relative color perception change was calculated based on the formula below and plotted over time. The gradient of the linear fit of this plotted data resulted in the average linear color degradation rate of each formulation (see tables 6 to 8).

$$Δ {E}_{00}^{⋆} = \sqrt{{( \frac{Δ {L}^{′}}{{k}_{L} {S}_{L}} )}^{2} + {( \frac{Δ {C}^{′}}{{k}_{C} {S}_{C}} )}^{2} + {( \frac{Δ {H}^{′}}{{k}_{H} {S}_{H}} )}^{2} + {R}_{T} \frac{Δ {C}^{′}}{{k}_{C} {S}_{C}} \frac{Δ {H}^{′}}{{k}_{H} {S}_{H}}}$$

TABLE 6
Average linear color degradation rate of formulations 1 to 7

Average linear color
degradation rate

| Formulation | Run 1 | Run 2 |
|---|---|---|
| 1 comp. | 0.28 | |
| 2 comp. | 0.25 | |
| 3 comp. | 0.15 | 0.28 |
| 4 | | 0.32 |
| 5 | | 0.29 |
| 6 | 0.13 | |
| 7 | | 0.34 |

TABLE 7
Average linear color degradation rate of formulations 8 to 13

Average linear color
degradation rate

| Formulation | Run 1 | Run 2 |
|---|---|---|
| 8 comp. | 0.27 | |
| 9 comp. | 0.20 | |
| 10 comp. | 0.27 | 0.30 |
| 11 | | 0.22 |
| 12 | 0.12 | |
| 13 | | 0.19 |

TABLE 8
Average linear color degradation rate of formulations 9 to 18

Average linear color
degradation rate

| Formulation | Run 1 | Run 2 |
|---|---|---|
| 14 comp. | 0.29 | |
| 15 comp. | 0.19 | |
| 16 comp. | 0.19 | 0.24 |
| 17 | 0.10 | |
| 18 | | 0.26 |

From this data it can be clearly seen that not only the congealing point of the Fischer-Tropsch waxes is important for reducing the color degradation in hot melt adhesives (the higher the congealing point the better), but also that it is important that the waxes are hydrotreated. Nevertheless, it can also be seen that hydrotreating alone is not decisive and that hydrotreated waxes with a low Saybolt-color can surprisingly outperform similar waxes with a high Saybolt-color in reducing the color degradation. Without being bound to this theory it is assumed that one reason for that is the carbon chain distribution of the according waxes and that a narrower distribution represented by a smaller polydispersity value is more important than a low Saybolt-color of the used wax.

1. Use of a hydrotreated synthetic Fischer-Tropsch wax in polyolefin-based hot melt adhesive compositions to modify the color degradation of the hot melt adhesive composition, wherein the hydrotreated synthetic Fischer-Tropsch wax is characterized by
a congealing point in a range of 75 to 110° C.;
a Saybolt-color according to ASTM D 156 below or equal to 29; and
a polydispersity ÐM=Mw/Mn of between 1.02 and 1.06.

2. The use according to claim 1, wherein the hydrotreated synthetic Fischer-Tropsch wax has a molecular mass (number average) between 500 and 1200 g·mol⁻¹, preferably between 600 and 1000 g·mol⁻¹ and more preferably between 880 and 920 g·mol⁻¹.

3. The use according to any of the preceding claims, wherein the hydrotreated synthetic Fischer-Tropsch wax has a content of branched hydrocarbons be-tween 10 and 25 wt.-%.

4. The use according to any of the preceding claims, wherein the hydrotreated synthetic Fischer-Tropsch wax has a congealing point the range of 90 to 105° C.

5. The use according to any of the preceding claims, wherein the hydrotreated synthetic Fischer-Tropsch wax has a Saybolt-color according to ASTM D 156 of below or equal to 10.

6. The use according to any of the preceding claims, wherein the hydrotreated synthetic Fischer-Tropsch wax has polydispersity ÐM=Mw/Mn of between 1.03 and 1.05.

7. The use according to any of the preceding claims, wherein the hydrotreated synthetic Fischer-Tropsch wax is further characterized by one or more of the following properties:
a heat of fusion determined with differential scanning calorimetry of 200 to 250 J/g, more preferably of 207 to 245 J/g, even more preferably of 210 to 240 J/g and most preferably of 220 to 235 J/g;
a penetration at 25° C. of below or equal to 5 1/10 mm, more preferably below or equal to 1 1/10 mm;
a penetration at 40° C. of below or equal to 10 1/10 mm; and
a Brookfield viscosity at 135° C. of above or equal to 10 mPa·s, more preferably above or equal to 12 mPa·s.

8. The use according to any of the preceding claims, wherein the hydrotreated synthetic Fischer-Tropsch wax is used in an amount of 2 to 40 wt.-%, preferably 5 to 30 wt.-%, in the polyolefin-based hot melt adhesive composition.

9. The use according to any of the preceding claims, wherein at least one polyolefin polymer is present in the hot melt adhesive composition, preferably in the range of 20 to 80 wt.-%, more preferably in the range of 40 to 50 wt.-%.

10. The use according to any of the preceding claims, wherein an antioxidant is present in the hot melt adhesive composition, preferably in the range of 0.1 to 2 wt.-%.

11. The use according to any of the preceding claims, wherein a tackifier is present in the hot melt adhesive composition, preferably in an amount of 10 to 50 wt.-% and more preferably 20 to 40 wt.-%.

12. The use according to any of the preceding claims, wherein a process oil is present in the hot melt adhesive composition, preferably in an amount of 5 to 15 wt.-%.

13. The use according to claim 9, wherein the polyolefin polymer is selected from the group of amorphous poly-alpha-olefin copolymers (APAO), polypropylene homopolymers or polybutene homopolymers, preferably from the group of ethylene-propylene copolymers, ethylene-butene copolymers or ethylene-octene copolymers, more preferably with an ethylene- or propylene content of more than or equal to 50 wt.-%.
